(19) United States
(12) Patent Application Publication
(10) Pub. No.: US 2003/0065057 A1
(43) Pub. Date: Apr. 3, 2003

(54) Low specific gravity thermosetting resin composition and methods for preparing the same

(76) Inventors: Chi-Hoon Choi, Kyoungki-do (KR); Sang-Sun Park, Kyoungki-do (KR); Kye-Won Ahn, Seoul (KR); Jeong-Eek Rhee, Kyoungki-do (KR)

Correspondence Address: Pennie & Edmonds, LLP, 3300 Hillview Avenue, Palo Alto, CA, 94304, US

(21) Appl. No.: 10/085,152

(22) Filed: Feb. 25, 2002

(30) Foreign Application Priority Data
May 23, 2001 (KR) 2001-28431

(51) Int. Cl. C08J 9/32

(52) U.S. Cl. 523/219

(57) ABSTRACT

A low specific gravity thermosetting resin composition of high fluidization with excellent mechanical properties, and methods for preparing the same, wherein a thermosetting resin composition for outer plastic panel of an automobile is modified in that a part of the inorganic filler is replaced with a low specific gravity filler, and the type of a filler and a thickener are altered from those compounds normally used for car panels. The are light-weight. The process prevents the degradation of the low specific gravity filler which can normally occur under a general compacting pressure. The composition has superior plasticity even when press forming under a low pressure.

### FIELD OF THE INVENTION

The present invention relates to a low specific gravity thermosetting resin composition and methods for preparing the same, and more particularly, to a low specific gravity thermosetting resin composition of high fluidization with excellent mechanical properties and methods for preparing the same, wherein the conventional thermosetting resin composition for a plastic body panel of an automobile is modified in such a manner that a part of conventional inorganic filler is replaced with a low specific gravity filler, and the type of a filler and a thickener are altered, thus having the advantage of being light-weighted as well as preventing the break-up of a low specific gravity filler which can normally occur under a general forming pressure, thereby having superior plasticity even when press forming under a low pressure.

### BACKGROUND OF THE INVENTION

In general, the body panel of an automobile is manufactured by ‘sheet molding compound’ (referred to as SMC hereinafter) method. The source of the body panel of an automobile is a thermosetting resin and the specific gravity of a thermosetting resin varies according to the difference in mixing ratio, which depends on the manufacturing method and composition being used.

The schematic view of the SMC is shown in FIG. 1. In FIG. 1, intermediate resin mixture is coated to a predetermined thickness on top of carrier films present on both top and bottom by using a doctor blade, and glass fiber is infiltrated between them after it is cut into a predetermined length using a rotary chopper. The infiltrated glass fiber is then pressed while passing through a compaction roller and is finally formed into a sheet. SMC sheets do not have good workability due to insufficient viscosity, and the final product is obtained after maturing for about 3 days at 50° C. Thus obtained SMC sheets are introduced into a mold after they are cut into an appropriate size according to the size and shape of a desired product. In case of a body panel of an automobile, the product is relatively large and thus about 80-150 kgf/cm² of compacting pressure is required. However, the conventional thermosetting resin composition is not advantageous in that it is heavy because of its relatively high specific gravity and also requires an additional step of alloy thus not being economical with respect to cost-effectiveness.

### SUMMARY OF THE INVENTION

Therefore, the object of the present invention is to provide a method for manufacturing a thermosetting composite with low specific gravity for a body panel of an automobile, which can be effectively used in manufacturing plastic body panel of an automobile in view of its light-weight acquired by replacing a part of an inorganic filler used in the conventional thermosetting resin composition. The thermosetting composite also has a superior plasticity in press forming even at a low-pressure condition, acquired by using a physical thickener to avoid the possible break-up of a filler of low specific gravity that can occur under normal forming pressure.

### BRIEF DESCRIPTION OF THE DRAWINGS

FIG. 1 is a schematic view showing the process of manufacturing SMC according to an embodiment of the present invention.

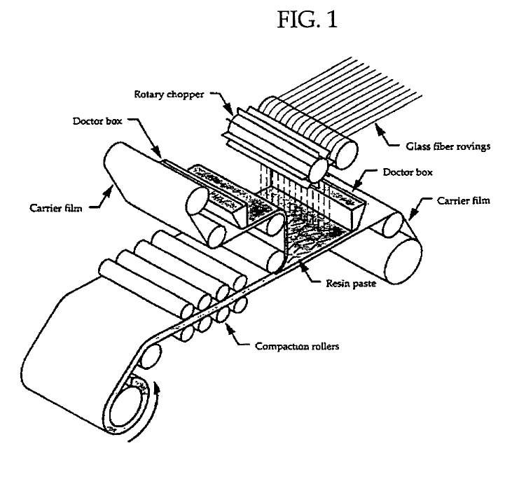

### DETAILED DESCRIPTION OF THE PREFERRED EMBODIMENTS

The present invention is described in detail as set forth hereunder. The compositions described and claimed are expressed as ingredients in a formulation that upon reaction and/or polymerization results in the composite compositions of this invention. One of skill in the art will realize the ingredients can change form and structure upon reaction or composition to form the composites of this invention.

The present invention relates to a thermosetting resin composition with low specific gravity comprising:

1-30 wt % of unsaturated polyester-based resin;

0.5-15 wt % of one selected from saturated crystalline polyester resin as a thickener as well as a low profile agent, unsaturated crystalline polyester resin as a thickener, or a mixture of these;

1-15 wt % of a filler with low specific gravity;

10-50 wt % of an inorganic filler;

1545 wt % of a fiber-type reinforcing agent;

0.5-35 wt % of a monomer;

0.01-2 wt % of an initiator;

optionally 0.1-5 wt % of a parting agent; and

optionally 0.01-5 wt % of additives.

The present invention also relates to a method of manufacturing a thermosetting resin composition with low specific gravity comprising: 1-30 wt % of unsaturated polyester-based resin; 0.5-15 wt % of one selected from saturated crystalline polyester resin as a thickener as well as a low profile agent, unsaturated crystalline polyester resin as a thickener, and a mixture of these; 1-15 wt % of a filler with low specific gravity; 10-50 wt % of an inorganic filler; 15-45 wt % of a fiber-type reinforcing agent; 0.5-35 wt % of a monomer; 0.01-2 wt % of an initiator; optionally 0.1-5 wt % of a parting agent; and optionally 0.01-5 wt % of other additives.

The present invention relates to a low specific gravity thermosetting resin composition and its manufacturing method, which can not only reduce manufacturing cost by comprising a filler with low specific gravity added in addition to the conventional low pressure forming resin composition for manufacturing a body panel of an automobile which comprises a fiber-type reinforcing agent and a filler as active ingredients while using unsaturated polyester-based resin as a matrix, but also improve the surface smoothness of a formed product by incorporating saturated crystalline polyester resin, which serves as a thickener as well as a low profile agent.

The present invention, for the purpose of low pressure forming suitable for manufacturing the body panel of an automobile, incorporates a filler with low specific gravity in combination with an inorganic filler while using unsaturated polyester resin as a matrix. The resulting composition, although its mechanical properties such as mechanical strength are somewhat inferior to those of conventional SMC materials for an automobile, is shown to be an excellent material for low pressure forming with superior plasticity at a forming pressure of below 20 kgf/cm², as well as superior storage stability.

The thermosetting resin composition with low specific gravity of the present invention is further explained by way of the manufacturing method described as follows.

The present invention uses unsaturated polyester-based resin as a matrix and it is preferred to be contained 1-30 wt % of the total composition, and more preferably 5-10 wt %. The unsaturated polyester-based resin is one or a mixture of more than two selected from the group consisting of iso-based resin, ortho-based resin, tere-based resin, modified bisphenol-based resin, and vinyl ester-based resin.

The present invention uses 0.5-15 wt %, preferably 1-10 wt %, of one selected from saturated crystalline polyester resin serving as a thickener as well as a low profile agent, unsaturated crystalline polyester resin as a thickener, and a mixture of these. If the amount is less than 0.5 wt %, the thickening effect and surface smoothness become poor, whereas physical properties become poor if the amount exceeds 15 wt %.

In an embodiment when saturated crystalline polyester resin is selected to be used, the surface smoothness of a formed product can be improved without using an additional low profile agent because it can serve both as a thickener and a low profile agent. On the other hand, when the above unsaturated crystalline polyester resin is selected to be used as a thickener, a low profile agent selected from the group consisting of polymethyl methacrylate (PMMA), polyvinyl acetate (PVAc), polyurethane (PU), polystyrene (PS), a polystyrene-based copolymer, or a mixture thereof is advantageously incorporated. The amount of low profile agent added is about 0-20%, in many embodiments 1-20 wt %, and preferably 2.5-10 wt % of the total resin composition.

The present invention uses an inorganic filler selected from the group consisting of calcium carbonate, mica, talc and clay, or mixture thereof, which is added 10-50 wt % of the total resin composition, and preferably 15-35 wt %. The density of calcium carbonate is around 2.7 g/cc, of mica around 3 g/cc, of talc around 2.8 g/cc, and of clay between 1.8 and 2.6 g/cc.

The present invention uses a filler with low specific gravity in combination with the above-mentioned inorganic filler, which results in cost reduction due to the light-weight of an automobile. By low specific gravity it is meant to have a specific gravity of about 1.5 g/cc or less, in a preferred embodiment 1 g/cc or less, more preferably 0.5 g/cc or less. In one embodiment the specific gravity of the filler is between about 0.1 g/cc and about 0.8 g/cc. The low specific gravity filler is preferably rigid and inorganic. Glass is a preferred inorganic filler, but glass typically has a density of about 2.8-3.5 g/cc. A hollow, i.e., gas filled, filler may advantageously be employed, for example hollow fibers, hollow spheres, other hollow bodies, and the like. A hollow glass sphere is preferred for the filler with low specific gravity. In one embodiment the specific gravity of glass spheres is about 0.37 g/cc. In another embodiment the specific gravity of the glass spheres is between 0.1 and about 0.6 g/cc. The amount used is 1-15 wt %, more preferably 3-10 wt %. If the amount is less than 1 wt %, the effect of light-weight becomes markedly reduced. In contrast, if the amount exceeds 15 wt %, the dispersion and distribution of resin composition during the mixing process become poor and also the physical properties become much worsened.

The present invention uses a fiber-type reinforcing agent which is fibers with a length less than about 10 mm in length, preferably 0.64-5.08 mm in length. The preferred amount of the reinforcing agent is 1545 wt %, and more preferably 20-35 wt %. The fiber is in one embodiment hollow.

The present invention uses a low molecular weight polymerizable compound, for example a polymerizable monomer or dimer, preferably a monomer, for thermosetting reaction and the preferred amount of the monomer is 0.5-35 wt %, and more preferably 2-25 wt %. The above monomer is in one embodiment selected from the group consisting of styrene, methyl methacrylate, divinyl benzene (DVB), α-methyl styrene, vinyl acetate, acrylate, or mixture thereof.

The present invention uses an initiator as a catalyst for thermosetting reaction and the preferred amount of the monomer is 0.01-2 wt %, and more preferably 0.1-1 wt %. The above initiator can be a peroxy-type initiator or other type initiator. In one embodiment the initiator is selected from the group consisting of peroxy ester, dialkyl peroxide, alkyl aryl peroxide, diaryl peroxide, peroxy ketal, ketone peroxide, and an azo compound.

The present invention uses a parting agent for the improvement of workability during release. The parting agent used in the present invention is either zinc stearate or calcium stearate. The amount of the parting agent is preferred to be 0.1-5 wt %, and more preferably 0.5-2 wt %.

In addition, the present invention optionally uses at least one additives selected from the group consisting of a pigment, a UV stabilizer, and a polymerization inhibitor, with the content being 0.01-5 wt %, and preferably 0.05-2 wt %.

While thickening is induced by using a metal oxide such as MgO, CaO, Mg(OH)₂, and Ca(OH)₂ in general SMC materials, the present invention employs a thermosetting composite material for SMC method, which is thickened by using a crystalline polymer resin.

Low pressure forming SMC is a novel material that can reduce expenses required for installing facilities and molds during initial investment because it enables forming of parts even at a much lower forming pressure as compared to those of conventional SMC. As in the case with conventional SMC pressure forming, the SMC of the present invention is also equipped with both upper and lower molds. The raw SMC materials in the form of a sheet can be cut into a predetermined size, placed on top of a lower mold, wherein resin is filled in by applying a pressure of 5-30 kgf/cm², and allowed to be cured for 2-5 min to finally produce a formed product.

Examples of major components of raw SMC materials for low pressure forming are unsaturated polyester, glass fiber and inorganic filler. Because the thickening mechanism of SMC of the present invention differs from those of conventional SMC, the compounding machine is a bit modified; namely, heating apparatus is installed near a compaction roller.

Thickeners used in general SMC are present in the form of a metal oxide such as MgO, CaO, Mg(OH)₂, and Ca(OH)₂, and are known to evenly disperse among unsaturated polyester polymer chains and induce chemical interactions thus achieving a thickening effect. In contrast, the present invention induces thickening effect by adding crystalline polyester instead of the above metal oxide. First, resin, crystalline polyester and other additives are dissolved by mixing them in a container kept at a temperature of higher than 80° C., delivered to carrier films by a doctor blade, added with glass fiber and then passed through a compaction roll as in the case of conventional SMC method. Here, it is heated to about 50° C. to maintain the crystalline polyester in a melted state within a predetermined mixing ratio, and crystallization takes place in the final step at room temperature thus resulting in a marked increase in viscosity.

Crystalline solid portion present in the crystalline polyester resin serves as a physical crosslinking point which not only shortens the thickening time but also makes an additional curing period unnecessary, thus enabling its immediate use in forming process after mixing. Besides, the thickening is not a chemical event and thus the storage stability is excellent and the workability and the properties can be well retained for about a year. These provide significant production advantages over the materials currently used.

Further, the present invention also aims at providing a resin composition wherein a thickener component can also serve as a low profile agent without adding an additional low profile agent to improve the surface smoothness of a formed product, and the resin composition can be used as a material suitable for manufacturing a body panel of an automobile having excellent external appearance of the surface as well as excellent mechanical properties. The amounts of glass fiber (specific gravity 2.5) and calcium carbonate (specific gravity 2.7), used as a reinforcing agent and an inorganic filler, respectively, are properly adjusted to make the specific gravity of the formed product kept in the range of 1.2-2, for example in a higher strength embodiment from 1.75-1.95, and for example in an intermediate-strength embodiment between about 1.3 and 1.7.

Thus obtained low pressure forming thermosetting plastic composite material can be used for manufacturing moving parts, side body panels, and hang-on parts such as hoods, doors, roofs, trunk lids, and the like of an automobile. In particular, about 15-35% reduction in body weight of an automobile can be achieved by manufacturing the body panel of an automobile to be 2.0-2.5 mm thick because the thickness of conventional steel is 0.65-0.75 m with specific gravity of 7.8. In addition, the materials manufactured by the SMC method according to the present invention can also contribute to cost reduction by having integration of parts because these materials are possessed with excellent corrosion resistance, impact resistance, dent resistance and plasticity as well as light-weight rendered on plastic materials.

In one embodiment of the invention there is a car panel formed from thermosetting resin composition consisting essentially of: between 1 and 30 wt % of unsaturated polyester-based resin; between 0.5 and 15 wt % of one selected from saturated crystalline polyester resin serving as a thickener as well as a low profile agent, unsaturated crystalline polyester resin as a thickener, or a mixture of these; between 1 and 15 wt % of a first inorganic filler with a specific gravity of less than about 1.5; between 10 and 50 wt % of a second inorganic filler; between 15 and 45 wt % of a fiber-type reinforcing agent; between 0.5 and 35 wt % of a low molecular weight polymerizable compound; between 0.01 and 2 wt % of an initiator; between 0.01 and 5 wt % of additives; and between 0.1 and 5 wt % of a parting agent. This composition is reacted to form a thermosetting composite which is formed into a car panel. In a preferred embodiment, the unsaturated polyester-based resin comprises iso-based resin, ortho-based resin, tere-based resin, modified bisphenol-based resin, vinyl ester-based resin, or a mixture thereof; the saturated crystalline comprises between 1 and 20 wt % of polymethyl methacrylate, polyvinyl acetate, polyurethane, polystyrene, and polystyrene-based copolymer; the first inorganic filler comprises hollow spheres, hollow fibers, hollow glass objects, or a mixture thereof with a specific gravity of between 0.1 and about 0.6 g/cc.; the second inorganic filler comprises calcium carbonate, mica, talc and clay; and the low molecular weight polymerizable compound comprises a monomer, dimer, or mixture thereof. Advantageously, the first inorganic filler has a specific gravity of about 0.1 to about 0.8, and the bulk density of the reacted composition is between about 1.3 and 1.7. In another embodiment, the first inorganic filler has a specific gravity of between about 0.1 and 0.6, and the bulk density of the reacted composition is between about 1.75 and 1.95. In a preferred embodiment, the first inorganic filler comprises hollow glass spheres that have a specific gravity of between about 0.1 and 0.8; the low molecular weight polymerizable compound comprises monomers of styrene, methyl methacryalte, divinyl benzene, α-methyl styrene, vinyl acetate, acrylate, or mixtures thereof; the second inorganic filler comprises calcium carbonate, mica, talc and clay; and the fiber-type reinforcing agent consists of glass fibers with a length less than about 10 mm in length present in amount between 20 and 35 wt %. Advantageously, the bulk density of the reacted composition of this preferred embodiment is between about 1.3 and about 1.75.

The invention also encompasses a sheet molding compound process for forming a formed product, particularly a car panel. The process requires: providing a composite sheet formed from a composition comprising between 1 and 30 wt % of unsaturated polyester-based resin, between 0.5 and 15 wt % of one selected from saturated crystalline polyester resin serving as a thickener as well as a low profile agent, unsaturated crystalline polyester resin as a thickener, or a mixture of these, between 1 and 15 wt % of a first inorganic filler with a specific gravity of less than about 1.5, between 10 and 50 wt % of a second inorganic filler, between 15 and 45 wt % of a fiber-type reinforcing agent, between 0.5 and 35 wt % of a low molecular weight polymerizable compound, between 0.01 and 2 wt % of an initiator, and between 0.1 and 5 wt % of a parting agent; placing the composite sheet in a mold adapted for a sheet-molding-compound-pressure-forming process; applying a compacting pressure, wherein the compacting pressure is 30 kgf per square centimeter or less; and curing the formed product. Advantageously, the first inorganic filler comprises hollow glass spheres that have a specific gravity of between about 0.1 and 0.8; the low molecular weight polymerizable compound comprises monomers of styrene, methyl methacryalte, divinyl benzene, α-methyl styrene, vinyl acetate, acrylate, or mixtures thereof; the second inorganic filler comprises calcium carbonate, mica, talc and clay; the fiber-type reinforcing agent comprises glass fibers with a length less than about 10 mm in length and is present in an amount between 20 and 35 wt %.; the parting agent comprises zinc stearate or calcium stearate; and the bulk density of the reacted composition is between about 1.3 and about 1.75.

This invention is explained in greater detail based on the following Examples but they should not be construed as limiting the scope of this invention.

### COMPARATIVE EXAMPLE 1

About 500 kg of samples in the form of a sheet were manufactured by using SMC mixing machine for mass production. The conditions of temperature, pressure and time used for forming were 150° C., 20 kgf/cm² and 210 sec, respectively. Flat type formed product was obtained by sample molding. Unsaturated polyester resin was prepared by mixing OS-108™ and OS-980™ (available from Aekyung Chemical Co., Ltd, Korea). The reinforcing agent was prepared by cutting glass fiber (RS4800-433™, available from Owens-Corning Korea) of roving type into 2.54 mm in size and calcium carbonate (Omyacarb 1T™, available from Omya Co., Ltd, Japan) was used as an inorganic filler. C772™ (available from Scott Bader Co., Ltd., England) was used as unsaturated crystalline polyester resin. The composition and the mixing ratio are shown in the following table 1 and the physical properties of samples are shown in table 3.

### COMPARATIVE EXAMPLES 2 AND 3

Low pressure forming SMC samples were manufactured by using the same conditions in the above Comparative Example 1 with the exception that the mixing ratio was modified. The specific mixing ratio used is shown in the following table 1 and the physical properties of samples are shown in table 3.

TABLE 1

| | *Comp. | *Comp. | *Comp. |
|---|---|---|---|
| Classification (wt %) | Ex. 1 | Ex. 2 | Ex. 3 |
| Unsaturated polyester resin-1 (OS- | 4.2 | 5.0 | — |
| 108 ™) | | | |
| Unsaturated polyester resin-1 (OS- | 5.0 | 6.0 | 11.0 |
| 980 ™) | | | |
| Low profile agent (LPV-40 ™) | 8.0 | 9.0 | 9.0 |
| Unsaturated crystalline polyester | 6.0 | 7.0 | 7.0 |
| resin (C772 ™) | | | |
| Monomer (Styrene) | 1.5 | 2.2 | 2.2 |
| Initiator (t-butyl perbenzoate) | 0.5 | 0.5 | 0.5 |
| Parting agent (zinc stearate) | 1.0 | 1.0 | 1.0 |
| Thickener (CaO) | 0.5 | 0.5 | 0.5 |
| Inorganic filler (Omyacarb 1T ™) | 48.3 | 43.8 | 43.8 |
| Glass fiber (RS4800-433 ™) | 25.0 | 25.0 | 25.0 |

*Comp. Ex.: Comparative Example

### EXAMPLES 1-4

Samples were manufactured by using the same conditions in the Comparative Example 1 with the exception that the types and contents of fillers were altered. The mixing ratio was determined considering the big difference in specific gravity present between the conventional inorganic filler (CaCO₃) and the filler with low specific gravity. As the filler with low specific gravity was used SCOTCHLITE™ Glass Bubble K-37™ (Bulk Density=0.37) (available from 3M Co., Ltd, USA), and C-772 or C-773 was used as a saturated crystalline polyester resin. The specific mixing ratio is shown in the following table 2 and the physical properties of samples are shown in table 3.

### EXAMPLES 5-7

Samples were manufactured by using the same conditions in the Example 1 with the exception that various forming pressures of 15, 30, and 40 kgf/cm² were applied. The physical properties of thus manufactured samples were measured and the results are shown in table 3.

TABLE 2

| | | | | * Ex. |
|---|---|---|---|---|
| Classification (wt %) | * Ex. 1 | * Ex. 2 | * Ex. 3 | 4-7 |
| Unsaturated polyester resin-1 (OS- | 15.1 | 11.5 | 11.6 | 12.1 |
| 108 ™) | | | | |
| Unsaturated polyester resin-1 (OS- | 3.0 | 3.3 | 3.5 | 3.5 |
| 980 ™) | | | | |
| Low profile agent (LPV-40 ™) | — | 9.5 | 10.0 | 10.5 |
| Unsaturated crystalline polyester | — | 7.0 | 7.0 | 7.0 |
| resin (C772 ™) | | | | |
| Unsaturated crystalline polyester | 6.5 | — | — | — |
| resin (C773 ™) | | | | |
| Monomer (Styrene) | 4.5 | 2.5 | 3.0 | 3.5 |
| Initiator (t-butyl perbenzoate) | 0.5 | 0.5 | 0.5 | 0.5 |
| Parting agent (zinc stearate) | 1.0 | 1.0 | 1.0 | 1.0 |
| Filler with Low Specific Gravity | 3.5 | 4.3 | 6.0 | 7.6 |
| (Glass Bubble K-37 ™) | | | | |
| Inorganic filler (Omyacarb 1T ™) | 36.5 | 29.6 | 24.5 | 19.3 |
| Glass fiber (R54800-433 ™) | 28.4 | 30.8 | 32.9 | 35.0 |
| Others | 1.0 | 1.0 | 1.0 | 1.0 |

* Ex.: Example

TABLE 3

| | | Tensile | Flexural | Flexural | Impact |
|---|---|---|---|---|---|
| | Specific | Strength | Strength | Modulus | Strength |
| Classification | Gravity ¹⁾ | (MPa) ²⁾ | (MPa) ³⁾ | (GPa) ³⁾ | (J/m) ⁴⁾ |
| *Comp. Ex. 1 | 1.95 | 77 | 170 | 12.1 | 790 |
| *Comp. Ex. 2 | 1.85 | 83 | 172 | 11.8 | 850 |
| *Comp. Ex. 3 | 1.81 | 79 | 175 | 11.5 | 820 |
| **Ex. 1 | 1.63 | 75 | 170 | 11.4 | 780 |
| **Ex. 2 | 1.50 | 74 | 165 | 11.0 | 710 |
| **Ex. 3 | 1.42 | 71 | 162 | 10.6 | 685 |
| **Ex. 4 | 1.31 | 69 | 158 | 10.1 | 650 |
| **Ex. 5 | 1.32 | 68 | 159 | 10.2 | 660 |
| **Ex. 6 | 1.33 | 69 | 157 | 9.8 | 630 |
| **Ex. 7 | 1.35 | 68 | 156 | 10.0 | 620 |

¹⁾ Specific gravity: ASTM 792
²⁾ Tensile strength: ASTM 638, Type I, Cross-head Speed = 5 mm/min
³⁾ Flexural Strength & Flexural Modulus ASTM 790, W = 25 mm × L = 75 mm, Crosshead Speed = 1.3 mm/min
⁴⁾ Impact strength: ASTM D256 (Izod type)
*Comp. Ex. = Comparative Example
**Ex. = Example

As described above, the thermosetting resin composition of the present invention uses unsaturated polyester-based resin as a matrix and comprises predetermined amounts of an inorganic filler and a filler with low specific gravity. It is formed by means of an SMC method and then applied to an automobile, thereby enabling:

Reduction of body weight of an automobile by about 30-45% as compared to those of steel products, and by about 10-30% as compared to the conventional SMC;

Reduction of the initial set-up expense as well as expense for molds by about 10-30% as compared to the conventional SMC by using low pressure forming SMC; and

Reduction of deterioration in physical properties due to break-down of a filler with low specific gravity because of the low pressure forming.

Further, the thermosetting composite resin composition of the present invention has an excellent plasticity and mechanical properties thus enabling an integration of formed parts which can lead to cost reduction, increase in fuel efficiency, and reduction in exhaust gas such as CO₂; enabling to improve quality of a product and reduce maintenance/repair cost when used for manufacturing body panels of an automobile due to its excellent dent resistance and impact resistance; and enabling to be used as a material suitable for manufacturing automobile parts by using plastic materials for externally invisible inner panels of doors, hoods, and roofs; outer body panels; radiator support panel or chassis parts such as cross member due to its excellent durability, which does not require the additional alloy unlike as in steel plates.

What is claimed is:

1 A thermosetting resin composition with low specific gravity comprising:
between 1 and 30 wt % of unsaturated polyester-based resin;
between 0.5 and 15 wt % of one selected from saturated crystalline polyester resin serving as a thickener as well as a low profile agent, unsaturated crystalline polyester resin as a thickener, or a mixture of these;
between 1 and 15 wt % of a filler with low specific gravity;
between 10 and 50 wt % of an inorganic filler;
between 15 and 45 wt % of a fiber-type reinforcing agent;
between 0.5 and 35 wt % of a monomer;
between 0.01 and 2 wt % of an initiator;
between 0.1 and 5 wt % of a parting agent; and
between 0.01 and 5 wt % of additives.

2. The composition of claim 1 wherein the unsaturated polyester resin is one or a mixture of more than two selected from the group consisting of iso-based resin, ortho-based resin, tere-based resin, modified bisphenol-based resin, and vinyl ester-based resin.

3. The composition of claim 1 wherein the saturated crystalline polyester resin contains between 1 and 20 wt % of a low profile agent selected from the group consisting of polymethyl methacrylate, polyvinyl acetate, polyurethane, polystyrene, and polystyrene-based copolymer.

4. The composition of claim 1 wherein the filler with low specific gravity is a glass sphere which is hollow inside.

5. The composition of claim 1 wherein the inorganic filler is one or a mixture of more than two selected from the group consisting of calcium carbonate, mica, talc and clay.

6. The composition of claim 1 wherein the low profile agent is selected from the group consisting of polymethyl methacrylate, polyvinyl acetate, polyurethane, polystyrene, and polystyrene-based copolymer.

7. The composition of claim 1 wherein the fiber-type reinforcing agent is glass fiber of 0.64-5.08 mm in length.

8. The composition of claim 1 wherein the monomer is selected from the group consisting of styrene, methyl methacryalte, divinyl benzene, α-methyl styrene, vinyl acetate and acrylate.

9. The composition of claim 1 wherein the initiator is selected from the group consisting of peroxy ester, dialkyl peroxide, alkyl aryl peroxide, diaryl peroxide, peroxy ketal, ketone peroxide, and an azo compound.

10. The composition of claim 1 wherein the parting agent is zinc stearate or calcium stearate.

11. The composition of claim 1 wherein the additives are one or a mixture of more than two selected from the group consisting of a pigment, a heat stabilizer, a UV stabilizer and a polymerization inhibitor.

12. A method of manufacturing a thermosetting resin composition with low specific gravity comprising:
forming a reaction composition by admixing
between 1 and 30 wt % of unsaturated polyester-based resin;
between 0.5 and 15 wt % of one selected from saturated crystalline polyester resin serving as a thickener as well as a low profile agent, unsaturated crystalline polyester resin as a thickener, and a mixture of these;
between 1 and 15 wt % of a filler with low specific gravity;
between 10 and 50 wt % of an inorganic filler;
between 15 and 45 wt % of a fiber-type reinforcing agent;
between 0.5 and 35 wt % of a monomer;
between 0.01 and 2 wt % of an initiator;
between 0.1 and 5 wt % of a parting agent; and
between 0.01 and 5 wt % of additives; and
reacting the reaction composition to form a composite.

13. The method of claim 12 wherein the saturated crystalline polyester resin contains between 1 and 20 wt % of a low profile agent selected from the group consisting of polymethyl methacrylate, polyvinyl acetate, polyurethane, polystyrene, and polystyrene-based copolymer.

14. A car panel formed from thermosetting resin composition consisting essentially of:
between 1 and 30 wt % of unsaturated polyester-based resin;
between 0.5 and 15 wt % of one selected from saturated crystalline polyester resin serving as a thickener as well as a low profile agent, unsaturated crystalline polyester resin as a thickener, or a mixture of these;
between 1 and 15 wt % of a first inorganic filler with a specific gravity of less than about 1.5;
between 10 and 50 wt % of a second inorganic filler;
between 15 and 45 wt % of a fiber-type reinforcing agent;
between 0.5 and 35 wt % of a low molecular weight polymerizable compound;
between 0.01 and 2 wt % of an initiator;
between 0.01 and 5 wt % of additives; and
between 0.1 and 5 wt % of a parting agent, wherein the composition is reacted to form a thermosetting composite which is formed into a car panel

15. The car panel of claim 14 wherein
the unsaturated polyester-based resin comprises iso-based resin, ortho-based resin, tere-based resin, modified bisphenol-based resin, vinyl ester-based resin, or a mixture thereof;
the saturated crystalline comprises between 1 and 20 wt % of polymethyl methacrylate, polyvinyl acetate, polyurethane, polystyrene, and polystyrene-based copolymer;
the first inorganic filler comprises hollow spheres, hollow fibers, hollow glass objects, or a mixture thereof with a specific gravity of between 0.1 and about 0.6 g/cc.;
the second inorganic filler comprises calcium carbonate, mica, talc and clay; and
the low molecular weight polymerizable compound comprises a monomer, dimer, or mixture thereof.

16. The car panel of claim 14 wherein the first inorganic filler has a specific gravity of about 0.1 to about 0.8, and wherein the bulk density of the reacted composition is between about 1.3 and 1.7.

17. The car panel of claim 14 wherein the first inorganic filler has a specific gravity of between about 0.1 and 0.6, and wherein the bulk density of the reacted composition is between about 1.75 and 1.95

18. The car panel of claim 14 wherein
the first inorganic filler comprises hollow glass spheres that have a specific gravity of between about 0.1 and 0.8;
the low molecular weight polymerizable compound comprises monomers of styrene, methyl methacryalte, divinyl benzene, a-methyl styrene, vinyl acetate, acrylate, or mixtures thereof;
the second inorganic filler comprises calcium carbonate, mica, talc and clay; and
the fiber-type reinforcing agent consists of glass fibers with a length less than about 10 mm in length present in amount between 20 and 35 wt %.; wherein the bulk density of the reacted composition is between about 1.3 and about 1.75.

19. A sheet molding compound process for forming a formed product comprising:
providing a composite sheet formed from a composition comprising between 1 and 30 wt % of unsaturated polyester-based resin, between 0.5 and 15 wt % of one selected from saturated crystalline polyester resin serving as a thickener as well as a low profile agent, unsaturated crystalline polyester resin as a thickener, or a mixture of these, between 1 and 15 wt % of a first inorganic filler with a specific gravity of less than about 1.5, between 10 and 50 wt % of a second inorganic filler, between 15 and 45 wt % of a fiber-type reinforcing agent, between 0.5 and 35 wt % of a low molecular weight polymerizable compound, between 0.01 and 2 wt % of an initiator, and between 0.1 and 5 wt % of a parting agent;
placing the composite sheet in a mold adapted for a sheet-molding-compound-pressure-forming process;
applying a compacting pressure, wherein the compacting pressure is 30 kgf per square centimeter or less; and
curing the formed product.

20. The method of claim 19 wherein the first inorganic filler comprises hollow glass spheres that have a specific gravity of between about 0.1 and 0.8;
the low molecular weight polymerizable compound comprises monomers of styrene, methyl methacryalte, divinyl benzene, a-methyl styrene, vinyl acetate, acrylate, or mixtures thereof;
the second inorganic filler comprises calcium carbonate, mica, talc and clay;
the fiber-type reinforcing agent comprises glass fibers with a length less than about 10 mm in length and is present in an amount between 20 and 35 wt %.;
the parting agent comprises zinc stearate or calcium stearate; and
wherein the bulk density of the reacted composition is between about 1.3 and about 1.75.
